(19) United States
(12) Patent Application Publication
(10) Pub. No.: US 2014/0121090 A1
(43) Pub. Date: May 1, 2014

(54) Sensor-based gear device for sealing used feminine hygiene articles

(71) Applicant: Ableman International Co., Ltd., Taipei (TW)

(72) Inventor: Po-Hui Lin, Taipei (TW)

(73) Assignee: Ableman International Co., Ltd., Taipei (TW)

(21) Appl. No.: 14/149,841

(22) Filed: Jan. 8, 2014

(51) Int. Cl. B31B 1/26

(52) U.S. Cl. CPC B31B 1/26
USPC 493/189

(57) ABSTRACT

A device for sealing a used feminine hygiene article is provided with a trash can; a sealing mechanism on top of the trash can and including a frame, a power supply, sensors disposed on the frame, a controller, a motor, two opposite rollers each including two gears on both ends respectively, the gears of one roller being meshed with the gears of an other roller, and a gear member meshed with one gear of one roller and operatively connected to the motor, and two rolls of thermoplastic rotatably supported by the frame and disposed above both the rollers wherein a gap is formed between the rollers, and open ends of the thermoplastics of the rolls of thermoplastic are pushed into the gap to engage each other; and a cover on top of the sealing mechanism and including a releasable ring member having a channel above the gap.

### BACKGROUND OF THE INVENTION

1. Field of the Invention The invention relates to disposal of used feminine sanitary articles and more particularly to a sensor-based gear device for sealing used feminine hygiene articles.

2. Description of Related Art

When faced with the task of disposing of a feminine hygiene product (e.g., sanitary napkin or tampon), a woman may drop the used hygiene product into a trash bin or flush the product down the toilet. These two methods, however, result in contaminated trash bins, odors, and clogged toilet drains. To avoid these consequences, a woman may leave the used hygiene product in place, which may lead to serious health problems, embarrassing odors, and leakage onto clothing. A woman may alternatively attempt to wrap the used product in toilet tissue before throwing the product into the bin. However, the used product typically bleeds through the tissue, leading to the same problems of contamination and odors. Thus, the need for improvement exists.

### SUMMARY OF THE INVENTION

It is therefore one object of the invention to provide a device for sealing a used feminine hygiene article comprising a trash can comprising a hinged door; a sealing mechanism disposed on a top of the trash can and comprising a plurality of connected frame members, a power supply, a plurality of sensors disposed on the frame members, a controller, a motor, two opposite rollers each comprising two gears on both ends respectively, the gears of one roller being meshed with the gears of an other roller, and a gear member meshed with one gear of one roller and operatively connected to the motor wherein the power supply, the sensors, the controller, the motor are electrically connected together, and two rolls of thermoplastic each with thermoplastic wound around, the rolls of thermoplastic being rotatably supported by the frame members and disposed above both the rollers wherein a gap is formed between the rollers, and open ends of the thermoplastics of the rolls of thermoplastic are pushed into the gap to engage each other; and a cover disposed on a top of the sealing mechanism and comprising a releasable ring member including a longitudinal channel directly above the gap; wherein the sensors are capable of sensing an article being dropping from the channel into the gap, generating an activation signal, and sending the activation signal to the controller; the controller activates the motor to drive the gear member; and the gear member rotates to rotate one gear of one roller which rotates one gear of an other roller in a direction opposite to that of one gear of one roller, thereby pulling down the thermoplastics to join the thermoplastics together to seal the article by the rolls of thermoplastic.

The above and other objects, features and advantages of the invention will become apparent from the following detailed description taken with the accompanying drawings.

### BRIEF DESCRIPTION OF THE DRAWINGS

FIG. 1 is a perspective view of a device for sealing used feminine hygiene articles according to the invention;

FIG. 2 is an exploded view of the device;

FIG. 3 is an exploded view of the cover of FIG. 2;

FIG. 4 is a perspective view of the sealing mechanism of FIG. 2;

FIG. 5 is an exploded view of the sealing mechanism of FIG. 4;

FIG. 6 is a perspective view of the motor and the gears shown in FIG. 5;

FIG. 7 schematically depicts a used feminine hygiene article being dropped into the device;

FIG. 8 schematically depicts, as a next step of FIG. 7, the used feminine hygiene article being dropped onto the sealing mechanism;

FIG. 9 schematically depicts, as a next step of FIG. 8, the used feminine hygiene article being dropped into the sealing mechanism; and

FIG. 10 schematically depicts, as a next step of FIG. 9, the used feminine hygiene article being pressed and sealed prior to dropping into the trash can for temporary storage.

### DETAILED DESCRIPTION OF THE INVENTION

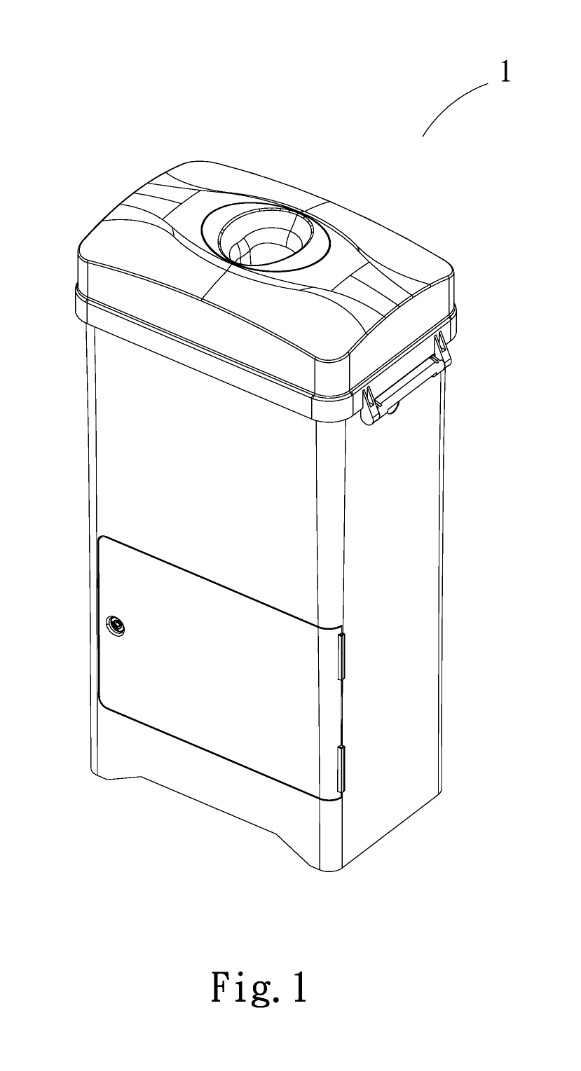

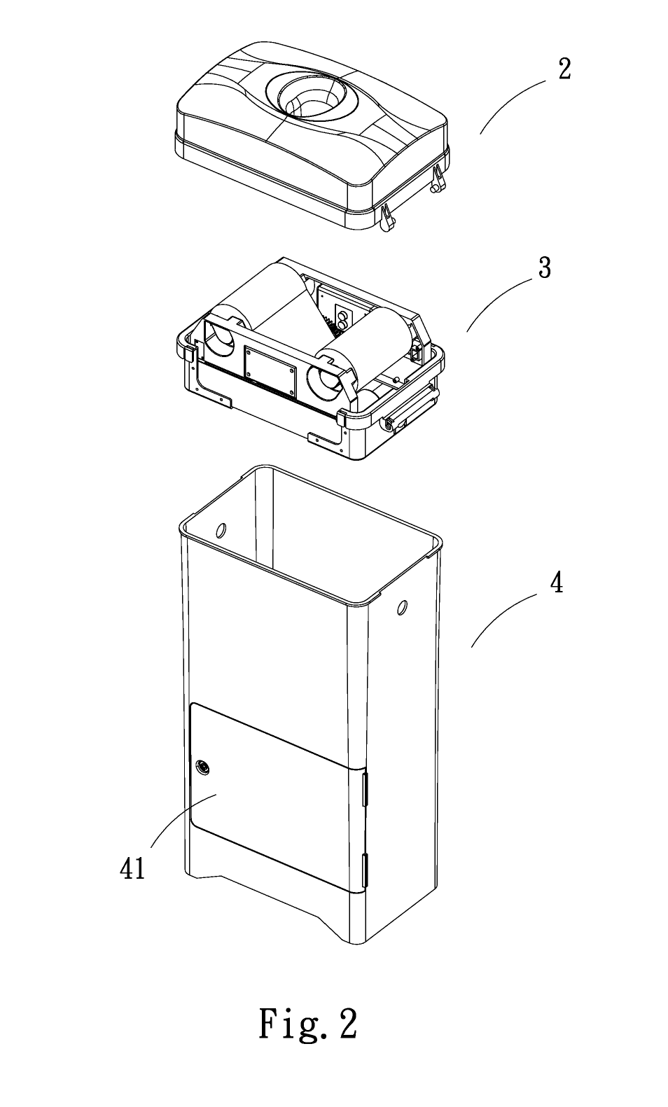

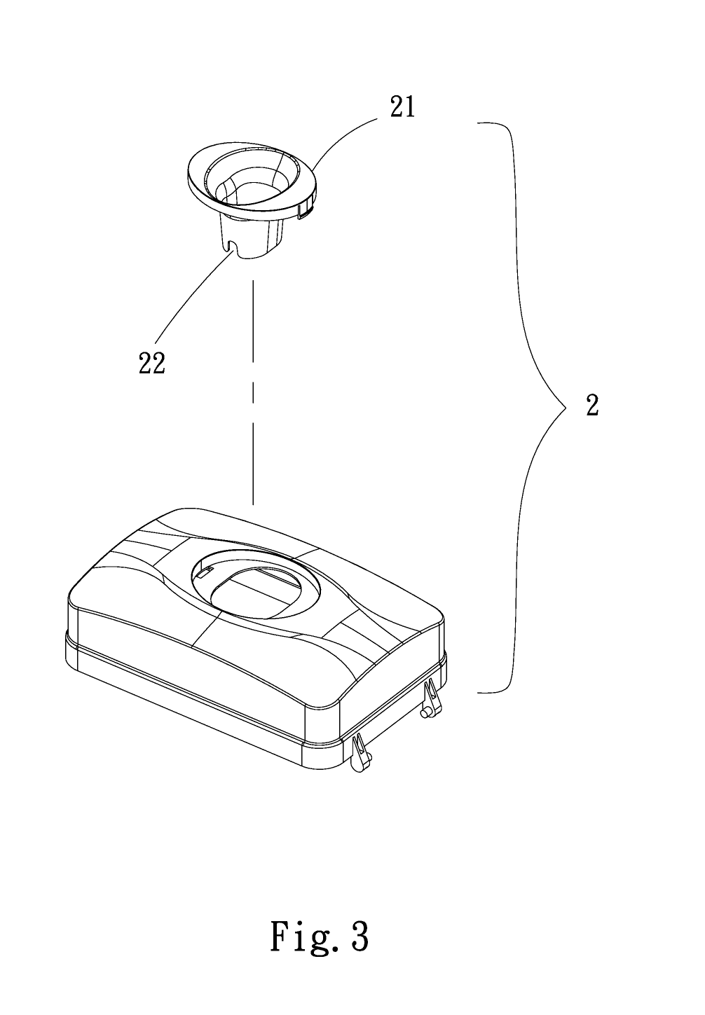

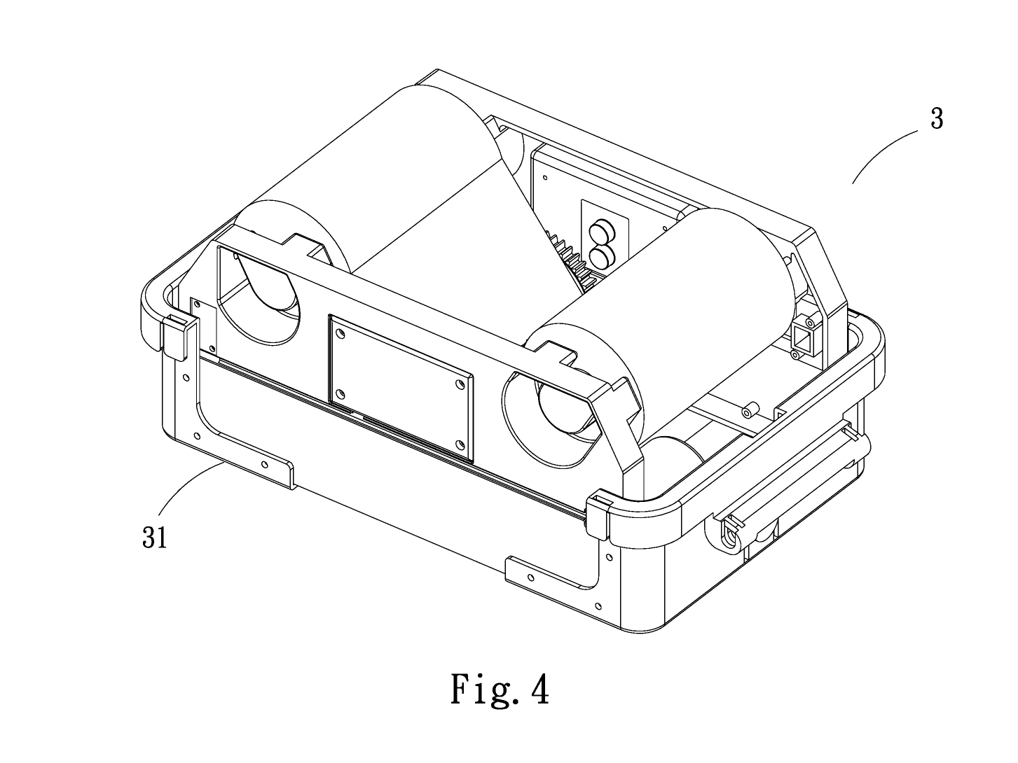

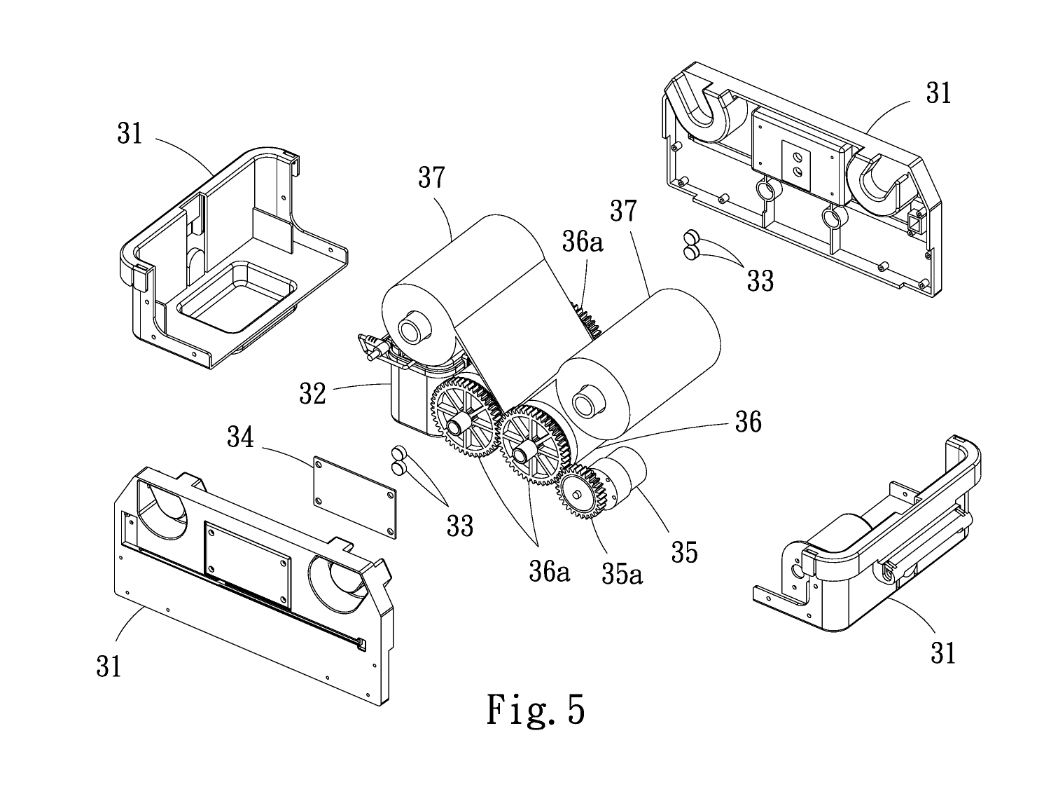

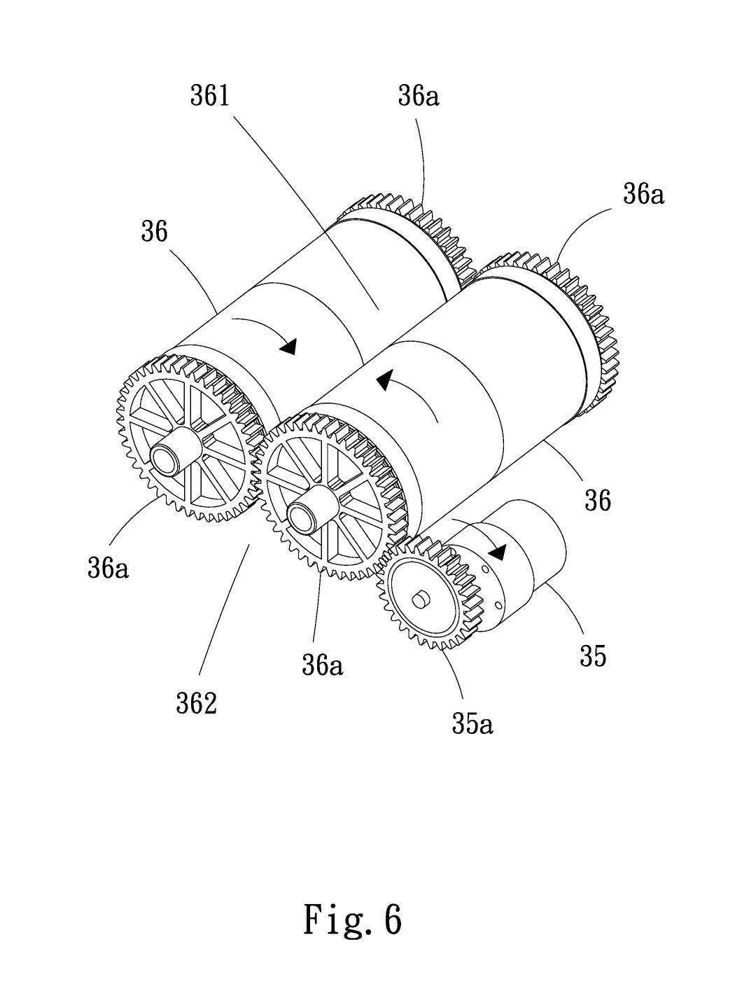

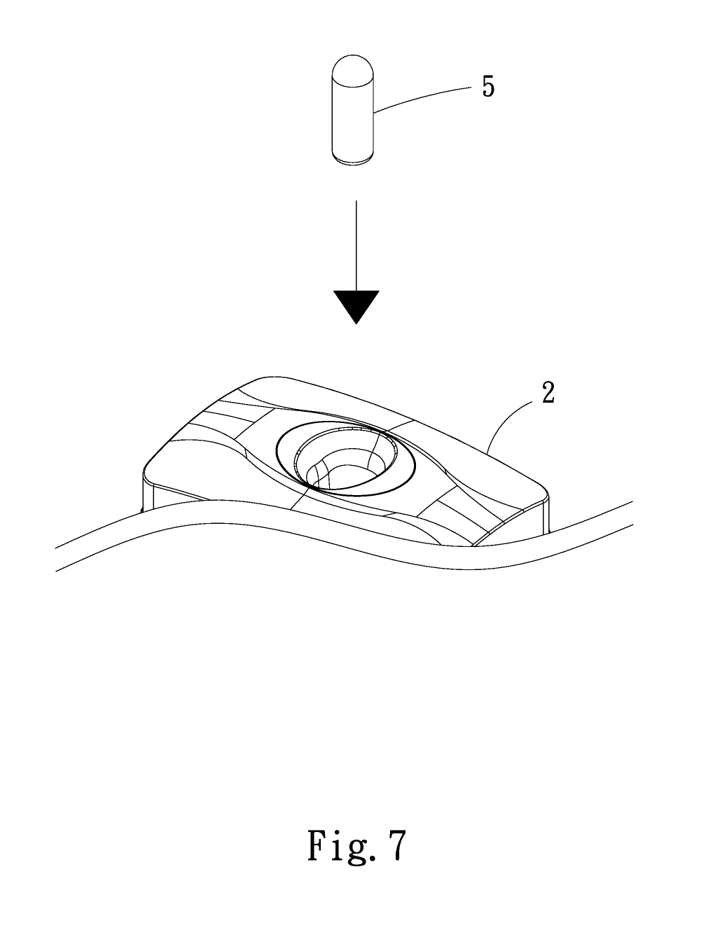

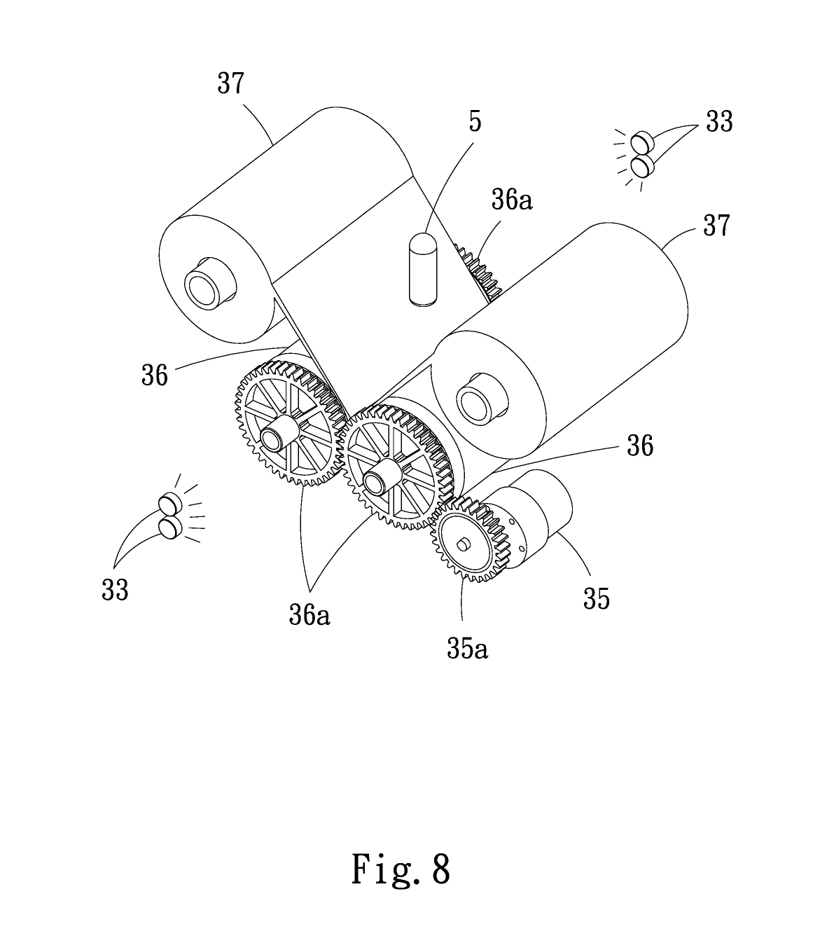

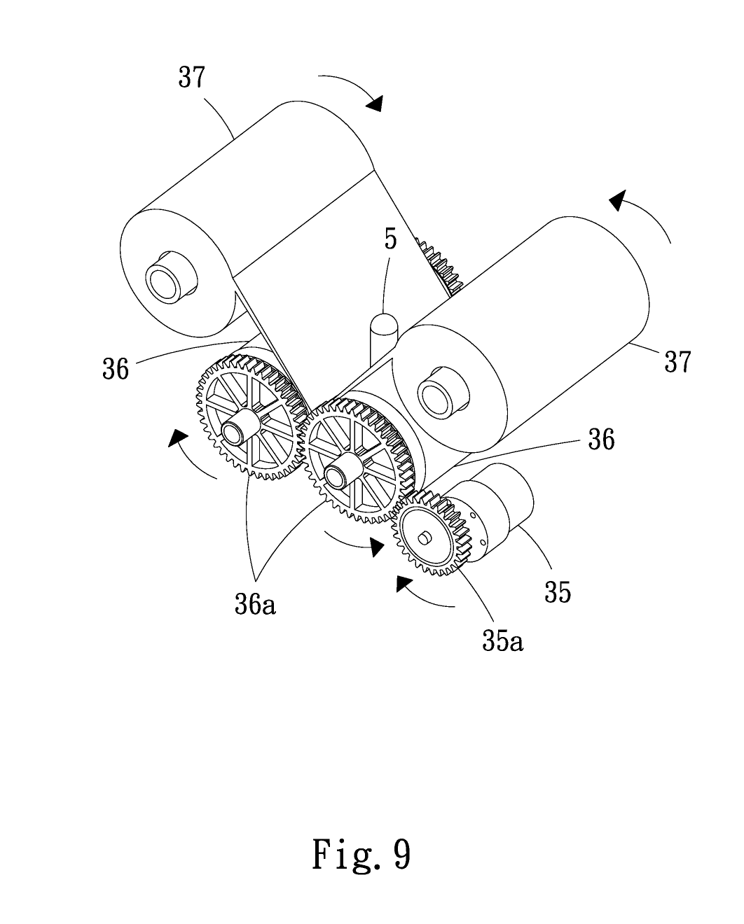

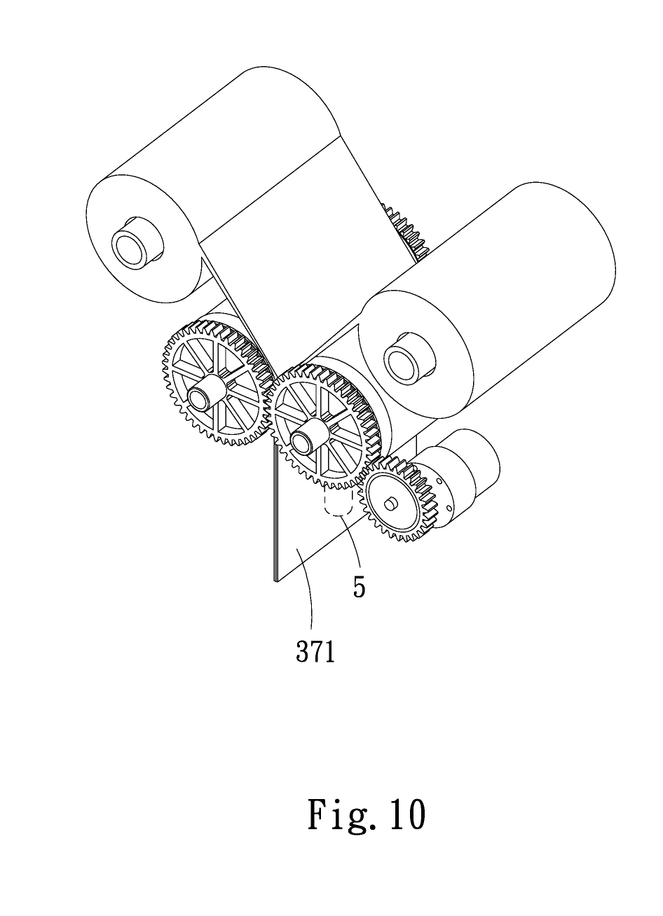

Referring to FIGS. 1 to 10, a device for sealing used feminine hygiene articles in accordance with the invention comprises the following components as discussed in detail below.

A trash can 4 is provided with a hinged front door 41. The trash can 4 has a section of rectangle. A sealing mechanism 3 is provided on a top opening of the trash can 4. A cover 2 is provided to conceal a substantial portion of the sealing mechanism 3. The cover 2 comprises a releasable ring member 21 including a longitudinal channel 22 communicating with the sealing mechanism 3 and the external.

The sealing mechanism 3 as the subject of the invention comprises four frame members 31 fastened together as a frame, a power supply (e.g., rechargeable battery) 32, a plurality of sensors (e.g., two sets of two sensors) 33 disposed on two opposite frame members 31 respectively, a controller 34 in the form of a circuit board, a motor 35, two cylindrical rollers 36 each having two gears 36a on both ends respectively, the gears 36a of one roller 36 being meshed with the gears 36a of the other roller 36, and a smaller gear member 35a meshed with one gear 36a of an adjacent roller 36 and driven by a drive shaft of the motor 35 so that both rollers 36 can rotate when the motor 35 is activated. The power supply 32, the sensors 33, the controller 34, and the motor 35 are electrically connected together. Further, a rotation direction of one gear 36a is opposite to that of the other gear 36a. The sealing mechanism 3 further comprises two rolls of thermoplastic 37. Each of the roll of thermoplastic paper 37 has both ends rotatably supported by two opposite frame members 31 and is disposed above both gears 36a of either roller 36. There is an elongated gap 361 between the opposite rollers 36. Initially, open ends of the rolls of thermoplastic 37 are pushed into the gap 361 to engage each other.

A disposing operation of the invention is discussed in detail below. A woman may drop a used feminine hygiene article 5 into the channel 22 through the ring member 21. Next, the used feminine hygiene article 5 is directed into the gap 361. The sensors 33 may sense the dropping used feminine hygiene article 5 before the used feminine hygiene article 5 enters the gap 361. The sensors 33 may generate and send a signal to the controller 34. The controller 34 may activate the motor 35 which in turn activates to drive the smaller gear member 35a. Further, the smaller gear member 35a rotates to counterclockwise rotate one gear 36a (i.e., one roller 36). The other roller 36 may rotate in an opposite direction (e.g., clockwise) due to the mesh engagement of the gears 36a of one roller 36 with the gears 36a of the other gear 36. And in turn, the thermoplastic wound around one roll of thermoplastic 37 is pulled down by one rotating roller 36 and the thermoplastic wound around the other roll of thermoplastic 37 is pulled down by the other rotating roller 36. The pulled down thermoplastics are joined together due to pressing of the rollers 36. As a result, the used feminine hygiene article 5 is sealed by the rolls of thermoplastic 37 and is dropped into the trash can 4. The sealing operation will be stopped after a predetermined period of time which has been set by the controller 34. A janitor (or cleaner) may regularly open the door 41 to remove the continuous thermoplastic stored in the trash can 4.

It is envisaged by the invention that odors of the used feminine hygiene articles 5 can be eliminated greatly.

Although the invention has been described in detail, it is to be understood that this is done by way of illustration only and is not to be taken by way of limitation. The scope of the invention is to be limited only by the appended claims.

What is claimed is:

1. A device for sealing a used feminine hygiene article comprising:
a trash can comprising a hinged door;
a sealing mechanism disposed on a top of the trash can and comprising a plurality of connected frame members, a power supply, a plurality of sensors disposed on the frame members, a controller, a motor, two opposite rollers each comprising two gears on both ends respectively, the gears of one roller being meshed with the gears of an other roller, and a gear member meshed with one gear of one roller and operatively connected to the motor wherein the power supply, the sensors, the controller, the motor are electrically connected together, and two rolls of thermoplastic each with thermoplastic wound around, the rolls of thermoplastic being rotatably supported by the frame members and disposed above both the rollers wherein a gap is formed between the rollers, and open ends of the thermoplastics of the rolls of thermoplastic are pushed into the gap to engage each other; and
a cover disposed on a top of the sealing mechanism and comprising a releasable ring member including a longitudinal channel directly above the gap;
wherein the sensors are capable of sensing an article being dropping from the channel into the gap, generating an activation signal, and sending the activation signal to the controller; the controller activates the motor to drive the gear member; and the gear member rotates to rotate one gear of one roller which rotates one gear of an other roller in a direction opposite to that of one gear of one roller, thereby pulling down the thermoplastics to join the thermoplastics together to seal the article.
